(19) United States
(12) Patent Application Publication
(10) Pub. No.: US 2026/0358587 A1
(43) Pub. Date: Nov. 12, 2026

(54) Ortho-Direct Optical Blind-mate Platform

(71) Applicant: Ciena Corporation, Hanover, MD (US)

(72) Inventors: Daniel Rivaud, Ottawa (CA); Fabien Colton, Kars (CA); David W. Boertjes, Nepean (CA)

(73) Assignee: Ciena Corporation, Hanover, MD (US)

(21) Appl. No.: 19/203,387

(22) Filed: May 9, 2025

(51) Int. Cl. G02B 6/42; H04B 10/80

(52) U.S. Cl. CPC G02B 6/4284; G02B 6/423; G02B 6/4261; G02B 6/428; H04B 10/801

(57) ABSTRACT

An optical interconnection apparatus is provided. The apparatus includes at least one horizontal card having an optical blind-mate connector, at least one vertical card positioned orthogonally to the horizontal card and having an optical blind-mate connector configured to directly mate with the optical blind-mate connector of the horizontal card, and a mechanical midplane positioned between the horizontal and vertical cards, configured to provide alignment of the optical blind-mate connectors to reduce float required during mating, wherein the vertical card includes an orifice configured to receive and hold an optical cable in a fixed position to enable blind mating to the horizontal card

### FIELD OF THE DISCLOSURE

The present disclosure relates generally to optical communication devices. More particularly, the present disclosure relates to apparatuses and methods for blind-mate Expanded Beam Optical connector mating between orthogonally oriented horizontal and vertical cards.

### BACKGROUND OF THE DISCLOSURE

Blind-mate optical backplanes are systems that enable automatic, cable-free optical connections between parallel cards using self-aligning connectors. Ortho-direct chassis are architectures that support orthogonal, cable-free electrical connections between horizontal and vertical cards. The conventional chassis architectures for high-density card-to-card interconnection are well established for electrical connectivity, enabling orthogonal mating of horizontal and vertical printed circuit boards without cable harnesses. However, these systems are not designed to support optical connectivity, and as a result, deploying fiber-optic interconnects in such platforms typically requires discrete cable assemblies and non-blind-mate connectors that must be manually routed and secured.

Separately, blind-mate optical backplanes are available in the marketplace for direct fiber mating, but these solutions position cards in parallel planes and do not accommodate ortho-direct, right-angle orientations. Systems that attempt to combine orthogonal card placement with optical interconnects today rely on multiple standalone components, such as midplanes, converter modules, and cable harnesses, which significantly increase the assembly labor, introduce opportunities for mis-mating and fiber damage, and elevate overall system cost. As a result, there remains a need for an integrated ortho-direct optical interconnection apparatus that enables true blind-mate fiber mating between orthogonally oriented cards without the drawbacks of cable-based architecture. As such, there remains a not yet met need for improved blind-mate optical backplanes for use in ortho-direct optics.

### BRIEF SUMMARY OF THE DISCLOSURE

The present disclosure relates generally to optical interconnection systems and mechanical midplane architectures. More specifically, the present disclosure provides an ortho-direct, blind-mate optical interconnection apparatus featuring orthogonally oriented horizontal and vertical cards, each equipped with precision-aligned Expanded Beam Optical connectors. Notably, the mechanical midplane minimizes float during mating by guiding and aligning the blind-mate connectors, while vertical card orifices securely hold optical cables in a fixed position to enable true blind mating. In some aspects, the midplane further integrates auxiliary functionality, such as an electrical busbar for power distribution or a liquid cooling manifold, to support active horizontal modules. Again, the vertical cards can be passive fiber interface modules with configurable routing and cable slack storage to facilitate shuffle, straight-through, or aggregation connectivity patterns. When compared to conventional optical backplanes and cable-based assemblies, the present disclosure enables direct, right-angle fiber mating with reduced labor, enhanced density, and robust reconfigurability.

In one aspect, disclosed is an optical interconnection apparatus, including at least one horizontal card having an optical blind-mate connector, at least one vertical card positioned orthogonally to the horizontal card and having an optical blind-mate connector configured to directly mate with the optical blind-mate connector of the horizontal card, a mechanical midplane positioned between the horizontal and vertical cards, configured to provide alignment of the optical blind-mate connectors to reduce float required during mating, and wherein the vertical card includes an orifice configured to receive and hold an optical cable in a fixed position to enable blind mating to the horizontal card.

In another aspect, disclosed is a mechanical midplane apparatus for use in an optical interconnection system, including a mechanical support structure positioned between horizontal and vertical cards oriented orthogonally to each other, guide pins configured to facilitate accurate alignment and mating of optical blind-mate connectors located on the horizontal and vertical cards, and at least one integrated functionality selected from the group consisting of an electrical busbar configured for power distribution, a manifold configured for liquid cooling fluid distribution, and interfaces for air-cooling distribution.

### BRIEF DESCRIPTION OF THE DRAWINGS

The present disclosure is detailed through various drawings, where like components or steps are indicated by identical reference numbers for clarity and consistency.

FIG. 1 is an isometric view of an embodiment of an optical ortho-direct platform in accordance with one aspect of the present disclosure.

FIG. 2 is an expanded isometric view of the optical ortho-direct platform of FIG. 1 in continuing accordance with an aspect of the present disclosure.

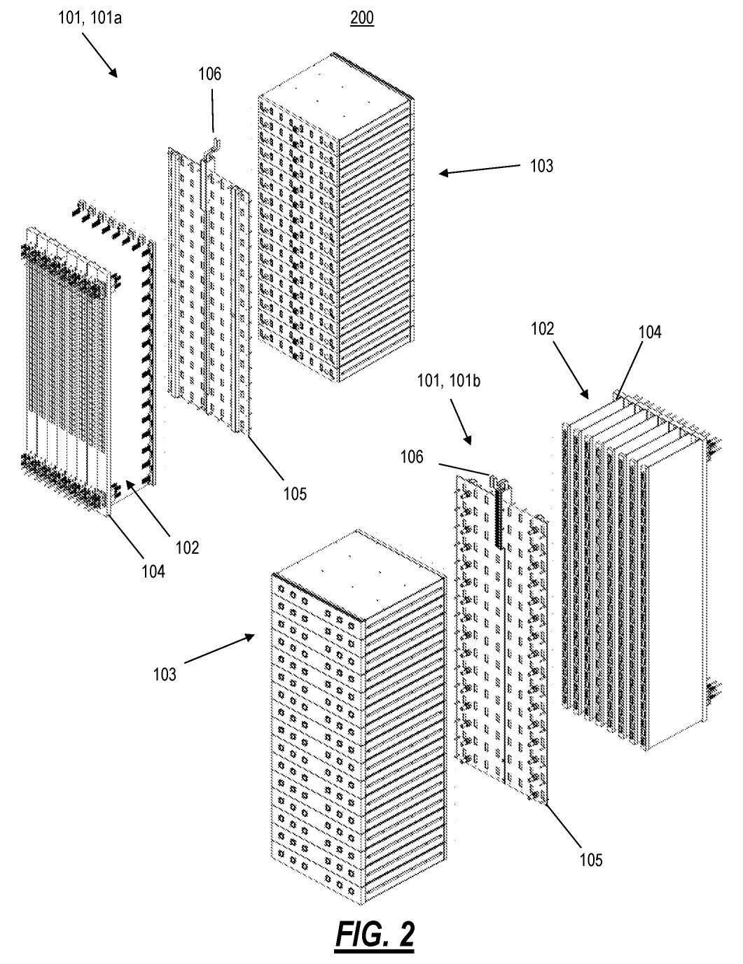

FIG. 3 is a cross-sectional view of the optical ortho-direct platform of FIG. 1 in continuing accordance with one aspect of the present disclosure.

FIG. 4 is a perspective, side view and zoomed view of an embodiment of an RM card in accordance with another aspect of the present disclosure.

FIG. 5 is a perspective view of an embodiment of a pair of TH6 cards in accordance with yet another aspect of the present disclosure.

FIG. 6 is an expanded view of a TH6 card depicted in FIG. 5 in continuing accordance with an aspect of the present disclosure.

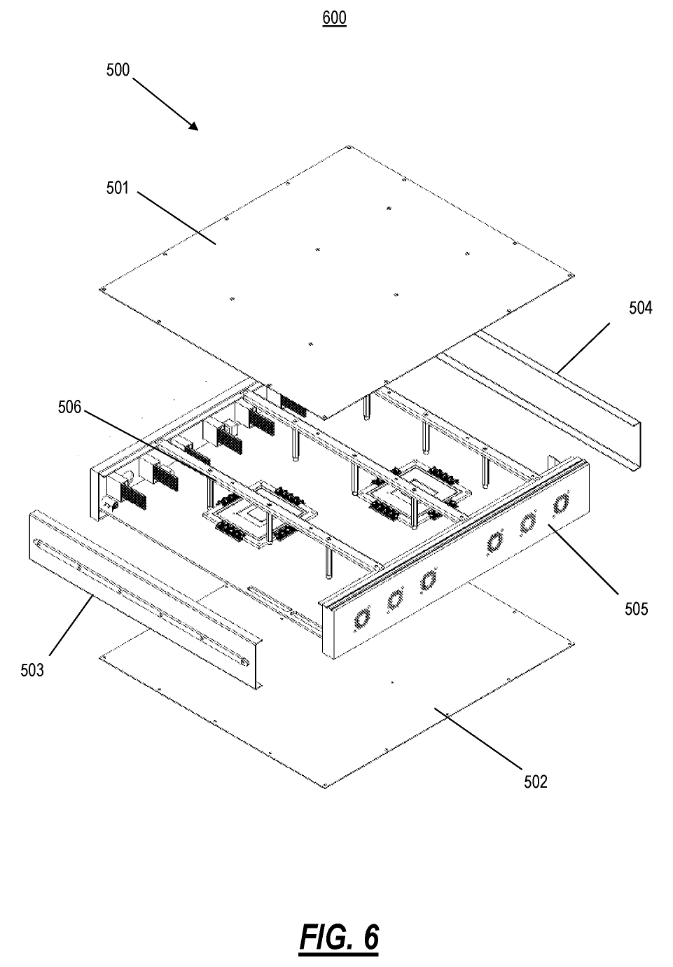

FIG. 7 is an internal schematic view of the pair of TH6 cards depicted in FIG. 5 in continuing accordance with an aspect of the present disclosure.

FIG. 8 is a collection of isometric views of an embodiment of a mounting structure in accordance with yet another aspect of the present disclosure.

FIG. 9 is a perspective view of a TH6 card as depicted in FIG. 5 connected to the mounting structure of FIG. 8 in accordance with yet another aspect of the present disclosure.

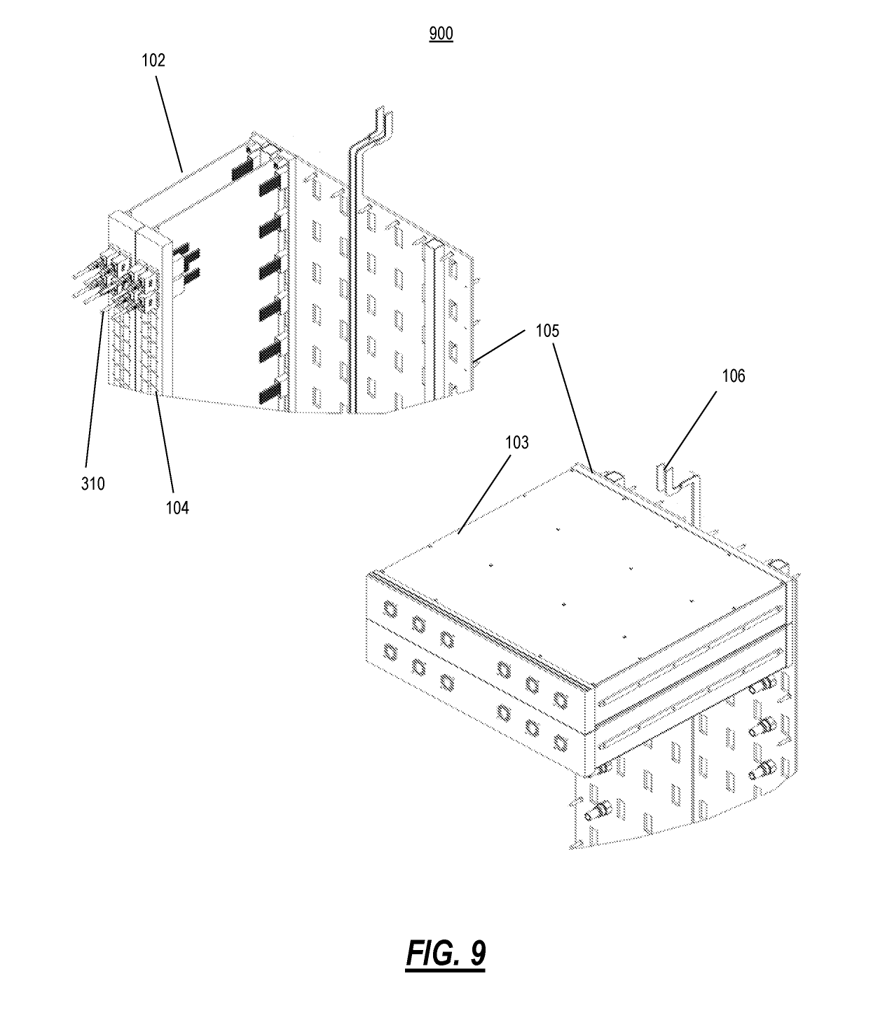

### DETAILED DESCRIPTION OF THE DISCLOSURE

### Optical Ortho-Direct Structure

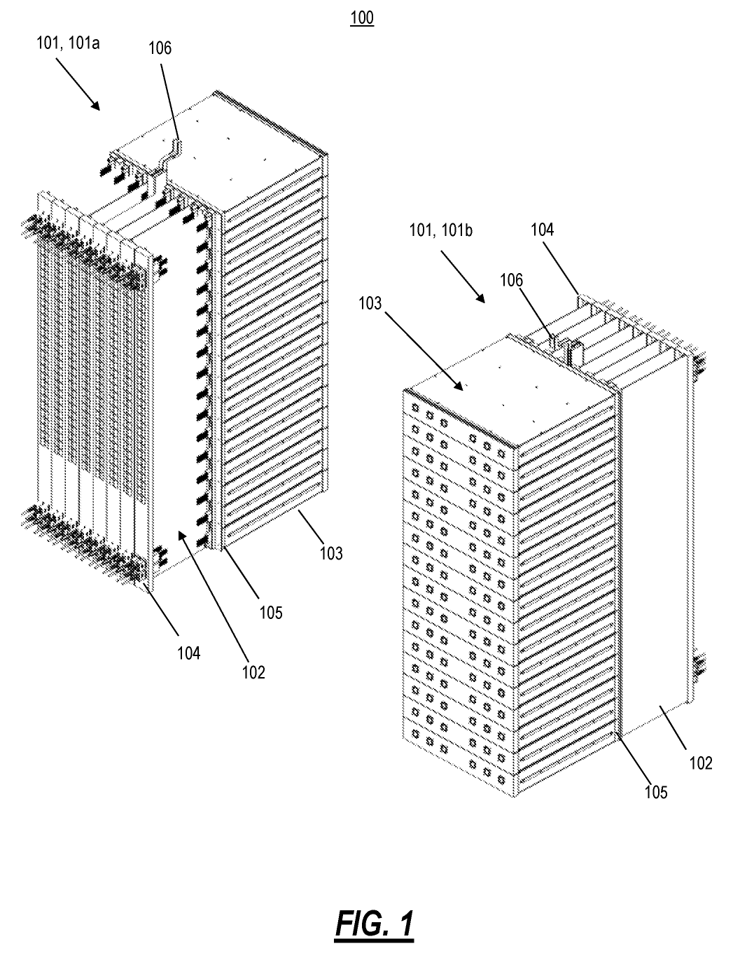

Turning now to FIGS. 1 & 2, an example embodiment 100 and an expanded embodiment 200 of an optical ortho-direct platform 101 is shown and described. More specifically, FIG. 1 provides a frontal view 101a of the platform 101 and a rearward view 101b of the platform. In some aspects, the platform 101 can define a rectilinear structure which can extend vertically. The platform 101 can include one or more vertical cards 102 and one or more horizontal cards 103. Any of the vertical cards 102 and/or the horizontal cards 103 can be stacked or aligned. More specifically, any of the vertical or horizontal cards 102,103 can be aligned with a next vertical or horizontal card 102,103 or arranged in any repeating pattern. For example, the vertical cards 102 can be stacked horizontally and the horizontal cards 103 can be stacked vertically. In some aspects, the vertical and horizontal cards 102, 103 can define a substantially rectilinear structure. It is envisioned that such a rectilinear structure can be configured to be stackable, modular, and adapted to attach to external surfaces.

In some aspects, the platform 101 can include a faceplate 104. The faceplate 104 can be joined to the card. More specifically, the faceplate 104 can be attached to the stack of vertical cards 102. The platform 101 can include a midplane 105. The midplane can be configured to mechanically and/or electrically couple the vertical cards 102 to the horizontal cards 103. The midplane 105 can be coupled to a busbar 106. The busbar 106 can provide electrical communication to the midplane 105 and optionally to the vertical and horizontal cards 102,103. More generally, the busbar 106 can provide electrical power to the platform 101.

The platform 101 includes a two-dimensional lattice of pluggable cards arranged in orthogonal planes, or more specifically the vertical and horizontal cards 102, 103. The vertical cards 102 can be mounted along a first axis, while the horizontal cards 103 can be mounted perpendicularly along a second axis. Each vertical card 102 can be an elongated, sheet-metal enclosure that occupies a full slot-height and extends from the front to the rear of the platform 101. Each vertical card 102 can be substantially hollow and define an internal routing volume, and the front and rear ends of the card terminate in faceplates that carry blind-mate optical connectors. The faceplate 104 and midplane 105 can be dimensioned to slide into machined slots in the chassis and lock into place via integrated mechanical latches.

Internally, the vertical card 102 can define a protected cable routing path which can be bounded by sidewalls and populated with cable guide features such as clips, loops, or trays. In example, fiber-optic cables are routed within this volume according to one of several predefined connectivity maps, and each cable terminates in a connector mounted to either the front or rear faceplate 104. The vertical card 102 frame includes a rigid spine and mounting flanges to support structural stability and connector alignment. Optional filler blanks may be inserted into unused slots to preserve thermal and mechanical uniformity.

In some aspects, the horizontal cards 103 can be rectangular modules that slide into the chassis along rails or guide slots aligned orthogonally to the vertical cards 102. Each horizontal card 103 can include a faceplate 104 populated with optical or electrical blind-mate connectors that interface directly with the rear-mounted connectors of the vertical cards 102. Each horizontal card 103 can define a body. The body of each horizontal card 103 may contain an active payload (such as a switching Application Specific Integrated Circuit (ASIC), Central Processing Unit (CPU), or memory) or passive circuitry. Any of the vertical cards 102 or the horizontal cards 103 can be structured to be aligned with any portion of the platform 101. More specifically, structural alignment can be accomplished through edge-guided contact points and optional retention latches. The horizontal card 103 can define a base at a lowermost portion thereof. In embodiments with thermal management, the horizontal card 103 base may integrate a cold plate or fan assembly secured to the chassis of the horizontal card 103.

In typical aspects, the vertical card 102 and the horizontal card 103 can meet to define an intersection. The intersection of the vertical and horizontal cards 102, 103 can locate the structural midplane 105. The midplane 105 can be operable to serve as a mechanical and functional interface between the two sets of cards (i.e., the vertical cards 102 and the horizontal cards 103.) The midplane 105 can be a planar structure mounted orthogonally within the chassis and can be fixed at multiple points to ensure rigidity and precise alignment. It can include cutouts or grommeted openings through which the connectors of both vertical and horizontal cards 102, 103 engage during insertion. The midplane 105 may further house embedded structures such as the busbars 106, cooling channels, and guide pins to constrain movement and facilitate blind-mating.

The overall chassis of platform 101 can be a rigid, rack-mountable frame with front and rear apertures to allow insertion and removal of cards (i.e., any of the vertical and horizontal cards 102, 103). The platform 101 can define an interior void having a volume. The interior volume can be subdivided into a grid of interlocking card slots, with tooling features such as captive rails, alignment bosses, and detents that ensure positional repeatability. The modular construction allows different vertical card types, for example, cards of varying height, width, or internal layout, to be interchanged without altering the structural backbone. Similarly, horizontal cards 103 of varying lengths and component configurations may be installed as long as they conform to the standardized footprint and connector pitch.

The system and platform 101 can be adapted for tool-less assembly and maintenance, with all major structural elements secured via snap-fit mechanisms, thumb screws, or slide-in brackets. The use of blind-mate connectors on both the vertical and horizontal cards 102, 103 can obviate the need for manual cable plugging during installation or hot-swapping. Structural features such as keyed rails, color-coded guides, and locking tabs reduce the risk of incorrect insertion. Optional blank panels or dummy cards may be inserted to maintain airflow integrity and structural uniformity in partially populated configurations.

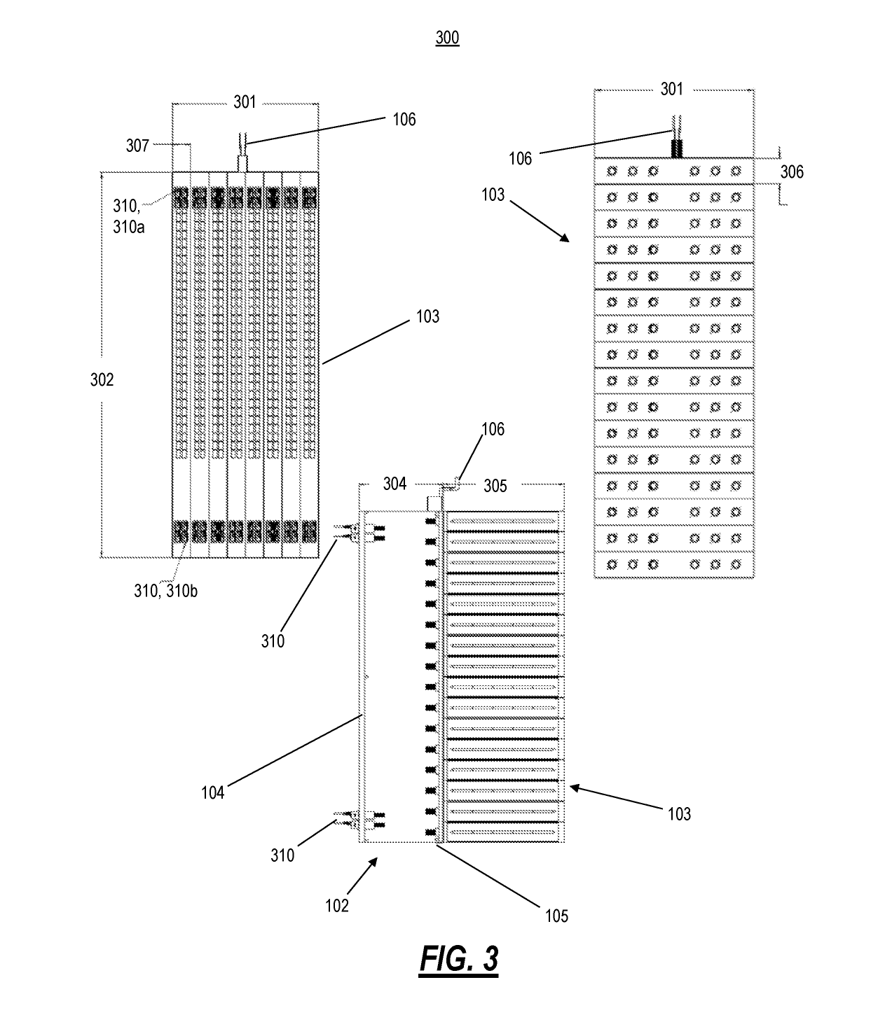

Turning now to FIG. 3, a cross-sectional view 300 of the optical ortho-direct platform of FIG. 1 is shown and described. As used herein, the term “RM Card can generally define a Radix multiplier card which can be performed by an optical shuffle function in the card. As used herein, the term “TH6” generally means which is an electrical packet switch which can have a CPO optical interface. The platform 101 can define a rack width 301. The rack width 301 can define a width, for example the width of the entire assembled platform 101. The platform 101 can define a card height 302. The card height 302 can be the height of each of the cards at a full stack and can be the total height of the platform 101. The platform 101 can define a RM card depth 304 and a TH6 card depth 305. In some aspects, the platform 101 can define a TH6 card thickness 306 and a RM card thickness 307.

In some aspects, the platform 101 can include an Expanded Beam Optical (EBO) connector 310. The EBO connector 310 can be disposed at any portion of the platform 101. For example, the EBO connector 310 can be disposed at a top portion of the faceplate 104 and a bottom portion of the faceplate 104 distal to the top portion. More specifically, the platform 101 can define a first EBO connector 310a and a second EBO connector 310b. For example only, without limitation, each EBO connector 310a, 310b can be mechanically secured to the chassis via brackets or fasteners integrated into the faceplate 104 frame, and positioned to align with predefined connector zones on the vertical cards 102. However, it is envisioned that the platform 101 can define any number of EBOs connector 310.

Each EBO connector 310 may include a housing that mates flush with the front surface of the platform 101, with blind-mate or guide-pin-aligned connectors that engage corresponding interfaces on the faceplate 104 or adjacent card edges. In some embodiments, the EBOs connector 310 serve as high-density optical breakout modules, routing multiple fiber connections between selected vertical cards and external trunk lines. Alternatively, EBOs connector 310 may support electrical, hybrid, or active optoelectronic functions depending on the configuration.

Structurally, the placement of EBO connector 310a at the upper region and connector EBO 310b at the lower region of the faceplate 104 provides symmetric routing paths for bundled cable harnesses or integrated flex circuits. Internal cable guides within the chassis may route fibers from the EBO connectors 310 vertically alongside the vertical cards 102 or through dedicated channels within the faceplate wall to minimize bend radius and preserve signal integrity. When not in use, EBO mounting bays can be sealed with blanking plates to maintain airflow and EMI containment. In some implementations, the EBO connectors 310 are hot-swappable and may include tool-less retention features, such as spring-loaded latches or sliding lock bars. Their modular nature allows different functional units, such as patch modules, transceiver blocks, or monitoring interfaces, to be inserted or replaced without disrupting the structural integrity of the chassis or other card assemblies.

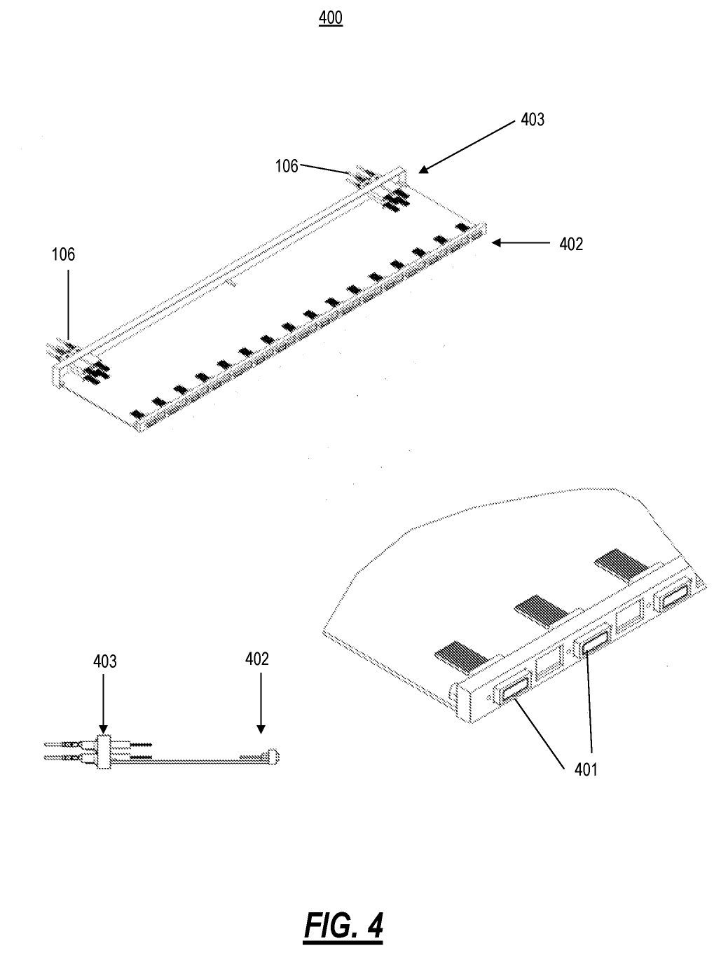

Turning now to FIG. 4, an embodiment of an RM card 400 is shown and described. The RM card 400 can include one or more optical ortho connectors 401. The ortho connectors 401 can be disposed at an ortho end 402 of the RM card 400. The ortho end 402 of the RM card 400 can be disposed distal to a faceplate end 403 of the RM card 400. In some aspects, the faceplate end 403 can be linearly displaced from the ortho end 402 by the RM card 400. The RM card 400 can be configured to engage orthogonally with a corresponding row of optical backplane connectors disposed within the platform 101. In some aspects, the ortho end 402 can include guide rails or alignment pins configured to interface with mating features on the platform 101 to ensure precise docking of the optical ortho connectors 401. When inserted, the RM card 400 can extend longitudinally from the faceplate end 403 to the ortho end 402, such that the optical ortho connectors 401 project laterally to mate with midplane or backplane optical interfaces oriented orthogonally to the insertion axis of the RM card 400.

For example only, and without limitation, in such configuration, the orthogonal connection geometry enables high-density optical interconnects between the RM card 400 and adjacent vertical cards 102 or rear transition modules without requiring curved or looped fibers. The linear displacement between the faceplate end 403 and the ortho end 402 defines a fixed insertion depth, which can be standardized across RM cards 400 of varying functionality to maintain uniform mechanical tolerances within the platform 101. Additionally, the RM card 400 can include internal optical routing structures, such as molded fiber channels or integrated waveguide paths, that direct optical signals from the faceplate-mounted transceivers or ports to the ortho connectors 401 while preserving signal integrity and minimizing insertion loss. In some embodiments, the RM card 400 further includes thermal dissipation features or EMI shielding elements aligned with apertures in the platform chassis to ensure operability under high-throughput conditions.

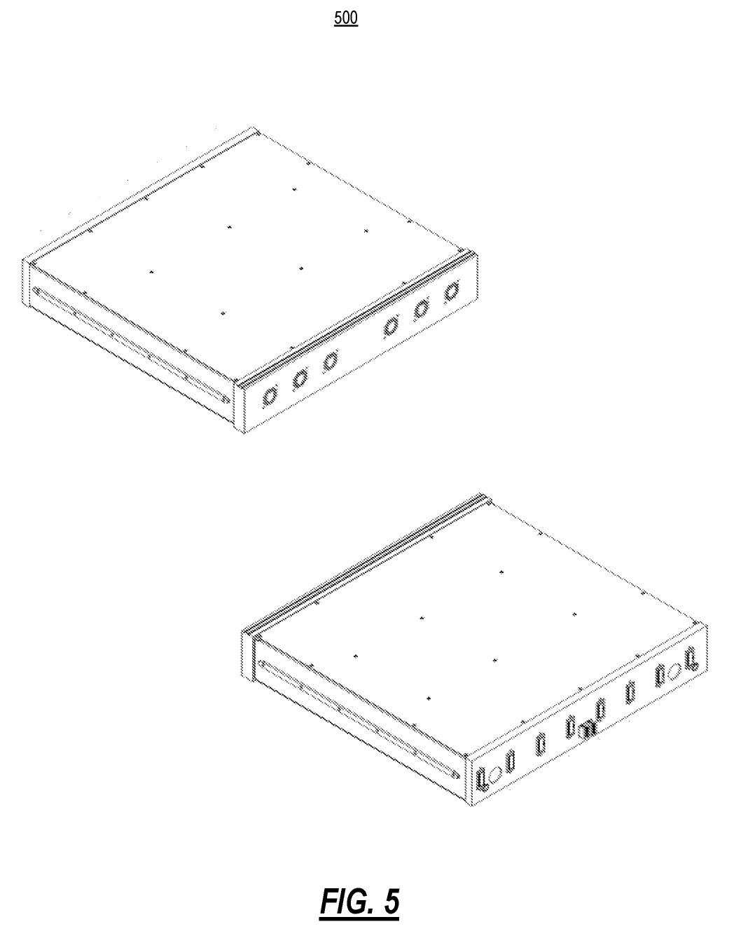

Turning now to FIGS. 5 & 6, an embodiment of a pair of TH6 cards 500 and an expanded view 600 of a TH6 card depicted in FIG. 5 is shown and described. The TH6 card 500 can define a substantially rectilinear or prismatic structure. In some aspects, the TH6 card 500 can be substantially thin with respect to its surface area. The TH6 card 500 can define a top cover 501 disposed at a top portion and a bottom cover 502 disposed at a bottom portion. The top cover 501 and the bottom cover 502 can house the contents of the TH6 card 500. Moreover, the top cover 501 and the bottom cover 502 can be substantially rectilinear.

The TH6 card 500 can include a front faceplate 503 and a rear faceplate 504. The front and rear faceplate 503, 504 can be disposed distal to each other and perpendicular to the top cover 501 and the bottom cover 502. In some aspects, the front & rear faceplates 503, 504 can intersect the top and bottom cover 501, 502 at a vertex edge. The TH6 card 500 can include one or more side panels 505. The side panels can intersect a vertex edge of the front and rear faceplates 503, 504 and the top and bottom cover 501, 502. The top and bottom cover 501, 502 can be substantially parallel to with each other and substantially perpendicular to the front and rear faceplates 503, 504 and the side panels 505. In some aspects, the TH6 card 500 can include a card stiffener 506. The card stiffener can be an elongated member which can intersect any two surfaces of the TH6 card 500. For example, the card stiffener 506 can extend from the front faceplate 503 to the rear faceplate 504. The card stiffener 506 can be structured to increase the rigidity of the TH6 card 500. The TH6 card 500 can include any number of card stiffeners 506.

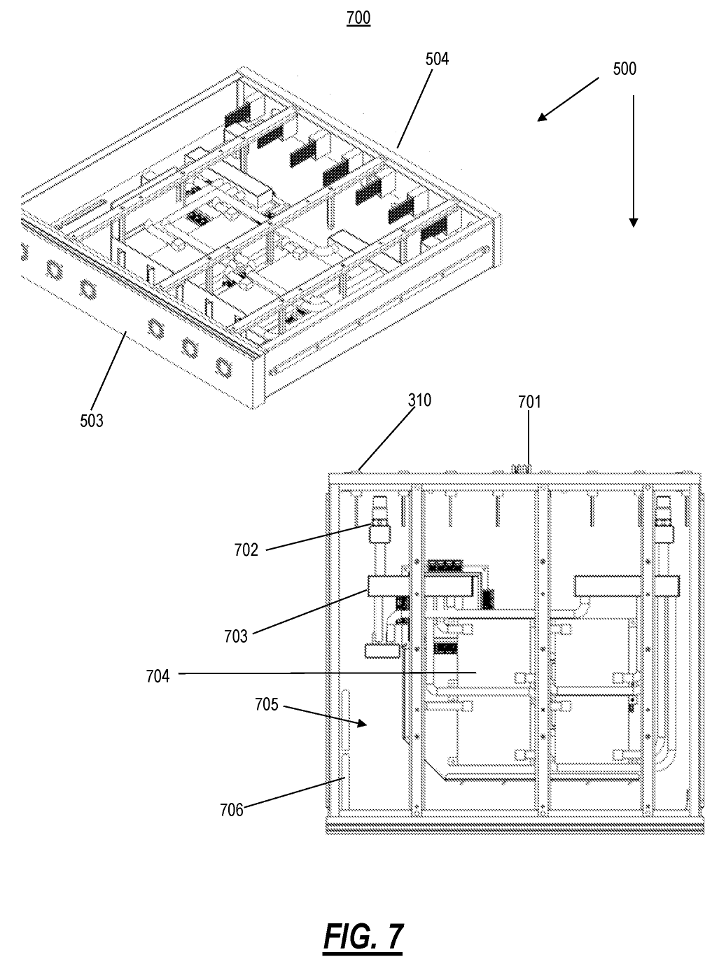

Turning now to FIG. 7, a pair 700 of TH6 cards 500 as depicted in FIG. 5 is shown and described. The TH6 cards 500 can include any of an input power port 701, the EBO connector 310, a liquid port 702, a liquid manifold 703, a coldplate 704, an internal baffle 705, a radiator & fan 706. In some aspects, the TH6 cards 500 can be configured to integrate a combination of thermal management, power delivery, and optical interconnection structures within a common module. The input power port 701 can be disposed along a first end of the TH6 card 500, proximate to a faceplate or service-accessible side of the card. The liquid port 702 can be spaced apart from the input power port 701 and can be fluidly coupled to the liquid manifold 703, which can be mounted internally to the TH6 card 500. The liquid manifold 703 can distribute coolant across multiple zones within the TH6 card 500 via internal channels or conduits formed into or coupled to the card’s frame.

The coldplate 704 can be thermally coupled to heat-generating components mounted on the TH6 card 500 and can interface directly with the liquid manifold 703 to transfer heat away from these components. In some aspects, an internal baffle 705 can be positioned within the liquid manifold 703 to direct fluid flow across specific regions of the coldplate 704, thereby optimizing thermal transfer efficiency. A radiator and fan assembly 706 can be mounted either integrally within or adjacent to the TH6 card 500 to exhaust heat from the liquid coolant into the ambient environment, enabling a closed-loop or hybrid liquid-air cooling system. The EBO connector 310 disposed on the TH6 card 500 can be positioned to align with corresponding optical or electrical interfaces on the platform 101, enabling simultaneous optical connectivity alongside thermal and power management functions. In some embodiments, the structural housing of the TH6 card 500 can further include flow barriers, EMI shielding, and structural ribs to maintain rigidity, thermal isolation, and electrical integrity across the interconnected modules.

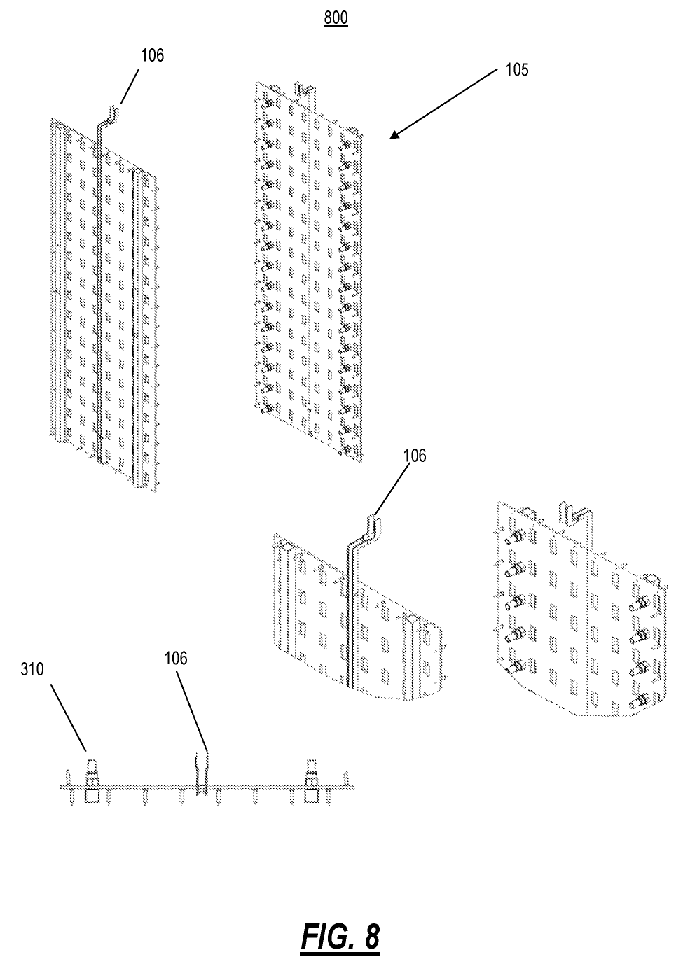

Turning now to FIGS. 8 & 9, an embodiment of a mounting structure 800 and a TH6 card as depicted in FIG. 5 connected to the mounting structure of FIG. 8 is shown and described. The assembly 900 can include a midplane 105 configured to receive and retain a plurality of functional modules along the faceplate 104. The faceplate 104 can be disposed at a front-facing surface of the midplane 105 and can define one or more openings, channels, or guide rails configured to accept corresponding module structures. The EBO connector 310 can be disposed along the faceplate 104, enabling optical and/or electrical signal interfacing between internal platform modules and external systems. In some aspects, the EBO connector 310 can be mounted adjacent to an edge of the faceplate 104 and can include a plurality of cable connectors, ports, or mating elements to facilitate high-density routing.

### Optical Interconnection Apparatus

In general, the present disclosure provides devices and apparatuses for optical interconnection. In one embodiment, the optical interconnection apparatus comprises a horizontal card and a vertical card arranged orthogonally, with their respective optical blind-mate connectors and directly mated to establish an optical path. A mechanical midplane is interposed between the horizontal and vertical cards, providing guide pins or sleeves to align the blind-mate connectors and reduce the required lateral and longitudinal float during engagement. The midplane may be formed from machined or molded metal or polymeric material holds the cards at fixed orthogonal orientations, ensuring repeatable alignment each time a card is inserted or removed.

In another embodiment, the platform can include optical blind-mate connectors employed on both the horizontal and vertical cards such as EBO connectors, each capable of transmitting at least 144 individual optical fibers. These connectors can employ a pair of collimating and focusing lenses to expand and refocus the optical beam across the mating interface, thereby permitting tolerance to dust, dirt, and minor angular or translational misalignment. Alternative connectors such as Octal Small Form-factor Pluggable (OSFP) or Multi-fiber Push On (MPO) types may be substituted on the faceplate side, provided they maintain comparable tolerance and fiber-count characteristics.

The mechanical midplane can further integrate additional system functions. For example, the electrical busbar may be incorporated into the midplane structure to distribute DC or AC power to electronic modules mounted on the horizontal card. In other variants, the midplane may house a liquid cooling manifold, featuring inlet and outlet ports and internal channels for coolant distribution. Still further, the midplane can be adapted with air-cooling interfaces, for example and without limitation as plenum passages or finned surfaces, to guide airflow across the cards for thermal management. More generally, the air-cooling interface can be any structure which extends the surface area of the base structure.

Vertical cards may be realized in several configurations. A fiber interface module (FIM) embodiment includes internal routing elements that perform straight-through, shuffle, or aggregation connectivity, enabling customizable mapping between front- and rear-facing optical ports. Alternatively, a passive vertical card fabricated from sheet metal or molded polymer can serve solely to mechanically support and route optical cables without electronic components. In certain aspects, the vertical card includes orifices or clamps to hold incoming optical cable assemblies in a fixed position, ensuring consistent blind-mate engagement with the horizontal card’s connector.

The horizontal card is designed for modular replacement and may carry active electronic component, for example and without limitation an optical circuit switch, electrical packet switches, GPUs, CPUs, Field Progammable Gate Arrays (FPGAs), or DRAM modules, directly adjacent to its blind-mate connector. Input/output optical connectors can be placed on a removable faceplate, allowing field-installable OSFP, MPO, or EBO connectors. In a system with multiple vertical cards, each may differ in functionality (e.g., one for shuffle connectivity, another for straight-through). Moreover, the apparatus can be configured such that the horizontal card can be removed or inserted without disturbing optical cables attached to the vertical card, and the vertical cards themselves may span the full height of a standard rack-unit enclosure to maximize fiber density

In some aspects, the present disclosure provides an optical blind-mate switching architecture which can be referred to as “ortho-direct.” The architecture can define any arrangement of horizontal cards which can be connected to vertical cards via the optical midplane. It is envisioned that such a connection can be established via the EBO connection, however other connector types are contemplated such as, without limitation Physical Contact (PC) connectors, air gap connectors, lens-based connectors, or the like. The connectors, such as the EBO connectors can be provided by any number or arrangement. For example, without limitation, the apparatus can include 144 EBO connectors.

In one embodiment, the Ortho-direct interconnection system comprises a rigid chassis into which a series of horizontal and vertical cards are installed at right angles to one another. The chassis can be constructed from, without limitation aluminum alloys, stainless steel, composites (i.e., fiberglass or carbon fiber), polymerics, copper, or any material which is substantially resistant. A mechanical midplane or frame can hold each horizontal card in a parallel plane and each vertical card in an orthogonal plane, with blind‐mate optical connectors at each intersection. In some aspects, the mechanical midplane can be configured to selectively release the cards. The chassis provides mounting slots and guide features to maintain card alignment during insertion and removal. For example, the chassis can include one or more card guides which can utilize snap-in or screw mounts, one or more rails with a spring biased tension, or the like. Further, it is envisioned that the chassis can include structures or mechanisms which can securely retain the card thereto, such as lock tabs, fingers, or any structure which can releasably secure the cards.

In alternative embodiments, the chassis may be adapted to different enclosure heights or depths or may omit the midplane entirely in favor of a free‐standing guide‐pin assembly. For example, the heights can be adjustable or configurable by an operator. The chassis can include an adjustment mechanism, such as and without limitation a telescoping portion, a modular portion, a collapsible or expandable structure, or the like. Each horizontal card carries one or more high‐speed switching ASICs, such as a packet switch with co-packaged optics (CPO) integrated at the die level. The ASIC can be any programmable logic device or ASIC which can be optimized for routing and switching with high throughput. The CPO devices mate directly to the blind-mate optics on the vertical cards, minimizing electrical trace length and improving signal integrity. In optional embodiments, horizontal cards may instead host a GPU with onboard transceivers, a DRAM memory module with optical I/O, an FPGA-based packet processor, or a standalone optical circuit switch (OCS). Connectorizing these alternate cards requires only that the blind-mate interface remain mechanically and optically compatible. Alternatively, the cards can include an FPGA, a network processor configured for packet processing, or a CPU.

Vertical cards can be dedicated to optical functions. For example and without limitation, the vertical cards can be configured for signal transmission and reception, wavelength division multiplexing, optical amplification, or any similar optical function. In one embodiment, the apparatus can include a Fiber Interface Module (FIM) and configured straight-through, shuffle, or aggregation routing of fiber channels between front- and rear-facing ports. In another, a fiber shuffle module permutes fiber positions to balance traffic loads across switch ASICs. A passive vertical card may be realized as a molded polymer or sheet‐metal tray that holds pre-terminated fiber cables in fixed orifices or clamps, requiring no active components. Alternative optical adapters, such as wavelength-selective multiplexers or simple fan-out devices, can be substituted without modifying the chassis.

The mechanical midplane can be adapted to provide alignment and float control for blind-mate engagement. For example, the blind-mate can include floating guide pins, alignment bushings, or any floating connector. In further example, the guide pins or alignment sleeves on the midplane can interface with corresponding holes on each card, limiting lateral and longitudinal movement to specified tolerances. In an optional embodiment, the midplane integrates an electrical busbar for DC power distribution to load‐bearing cards. More generally, the apparatus can include one or more DC power distribution source, including a power distribution panel, a cable harness, a power distribution block, or the like.

In another variant, a cooling system can be incorporated. The apparatus can be liquid cooled, air cooled, or a combination thereof. In one example, a liquid‐cooling manifold is incorporated, with internal channels and external quick-disconnect fittings to route coolant to cold plates on high-power devices. Air-cooling interfaces, such as aligned airflow passages or plenum spaces, may alternatively or additionally be integrated. The liquid cooling system can incorporate working fluids, such as coolant or water which can be circulated via a pump. Further, the apparatus can include one or more heat exchangers disposed in the fluid circuit. Alternatively, the apparatus can include one or more cold plates, which can be a plate having a large surface area which contacts the heat generating components. The cold plates can be disposed in the coolant circuit. The apparatus can be cooled via forced air cooling or natural cooling. More specifically, the apparatus can include structure which directs air through channels, wherein the channels are routed proximally or in contact with heat generating components. Further, the air cooling systems can route air through one or more plenum spaces disposed throughout the apparatus. In general, the apparatus or any portion thereof could also incorporate a phase-change cooling system, a thermoelectric cooling system, an immersion cooling system, one or more heat pipes, or a combination of any cooling system set forth herein.

Because optical connections are made via expanded-beam or similarly tolerant blind-mate interfaces, horizontal and vertical cards can be removed or installed without first disconnecting field-terminated fiber cables. Latches or ejector handles on each card provide tool-free removal. In one alternative, cards use spring-loaded retention clips that automatically engage when fully inserted and release via a push-button actuator. Some aspects of the apparatus include a release mechanism, such as a push-button actuator. In other examples, the locking and release mechanism can include, without limitation one or more thumb screws, sliding locks, magnetic latches, quick release levers, or any structure or mechanism which can releasably secure one or more cards to the apparatus. This modularity reduces system downtime and simplifies field upgrades or repairs.

It is envisioned that some embodiments can include an optimized or maximized port density. To maximize port density, the system can include dual-faceplate arrangements on both the front and rear of the chassis. Front-side cards may carry user-accessible optical or electrical I/O, while rear-side cards provide backplane connectivity. In a single-faceplate embodiment, only the front is exposed, reducing enclosure depth. Thermal management options can be replicated for both faceplates and can include air-cooled versions with integrated fan trays and duct work, liquid-cooled versions with midplane or card-mounted coolant channels, or hybrid arrangements combining both methods for high-power applications.

In one embodiment, the apparatus can include one or more EBO connectors. The EBO connector can comprise a collimating lens assembly and a focusing lens assembly arranged to expand and then refocus the optical beam across the mating interface. The collimating lens can enlarge the beam from the fiber core diameter (e.g., ~9 µm for single-mode or 50/62.5 µm for multimode) to several hundred micrometers. More generally, the EBO can be any device configured to reduce insertion loss and return loss. Notably, the larger beam can simplify cleaning and inspection as it is less affected by contaminants. The focusing lens on the opposing connector reconverges the beam into the mating fiber. Lens housings can be fabricated from precision-molded glass or polymer, and may include mechanical alignment features, such as keyways or sleeves, to ensure axial and angular positioning. In optional embodiments, anti-reflective coatings or index-matching gels can be applied to lens surfaces to reduce insertion loss. The anti-reflective coatings can be applied to minimize reflection and maximize light transmission while preventing energy loss. For example, the anti-reflective coatings can be, without limitation magnesium fluoride, silicone dioxide, titanium dioxide, zinc sulfide, zinc selenide, nanocomposites, or conductive polymer. The coating can be in a gel form, such as an index-matching gel.

In addition to decreasing the susceptibility to contaminants, by expanding the beam diameter, the connector drastically reduces sensitivity to lateral and angular misalignment. Typical alignment tolerances relax from sub-micrometer ranges in physical-contact ferrules to tens or even hundreds of micrometers with EBO. This tolerance enables robust blind-mate engagement in environments with vibration or thermal cycling. In alternative configurations, adjustable lens spacers or spring-loaded mounts can be incorporated to fine-tune the beam path and compensate for manufacturing tolerances or assembly drift.

EBO connectors can support densely packed multi-fiber arrays by tiling multiple lens channels within a single connector body. For example, a matrix of 12×12 lenslets can be arranged in a compact form factor to achieve 144 fiber channels. The lenslet array can be fabricated via micro-optics techniques, such as lithographic etching or precision glass molding. In optional embodiments, the connector body can include guide pins and block modules to allow interchangeable array sizes, for instance, 8×8, 16×16, or custom configurations, without altering the chassis or cable harness design. It is envisioned that alternative combinations of matrix sizes can be used for scalability and adaptability. Moreover the size of the matrix can be determined by factors such as space constraints, required channel count, and system design.

Because the optical beam is collimated at the interface rather than relying on direct fiber-to-fiber contact, EBO connectors exhibit high tolerance to dust and particulate contamination. Minor debris on the lens surface causes only minimal scattering and does not substantially degrade the focused beam. As a result, connectors typically do not require frequent cleaning or endface access. This characteristic makes EBO connectors well suited for installation in inaccessible locations, such as between orthogonal horizontal and vertical cards in a sealed enclosure. In some implementations, a protective shutter or dust cap can be added for additional environmental protection during periods of non-use.

Although EBO connectors generally exhibit slightly higher insertion loss, on the order of 0.5 to 1.0 dB per mated pair compared to <0.2 dB for physical-contact connectors, the trade-off is often acceptable in high-density or harsh environments. Loss can be mitigated through optimized lens designs, tighter manufacturing tolerances, or the use of low-loss glass materials. In alternative embodiments, hybrid connectors combining EBO and limited physical contact features can be provided to balance loss and tolerance requirements for specific applications.

The use of EBO connectors with the devices and apparatus of the present disclosure, by nature of the design of EBO connectors, enables vertical fiber carrier cards to exceed conventional printed-circuit-board size limits. A vertical carrier can span the full height of a standard rack unit, hosting multiple EBO connector arrays along its length to maximize fiber density. The carrier may include integrated cable routing channels or slack storage compartments to manage fiber bend radii. In optional configurations, vertical cards can interoperate with a midplane that provides mechanical alignment and additional electrical or cooling services, such as integrated busbars or liquid cooling manifolds, without requiring fiber access for maintenance.

Again, the present disclosure generally provides an all-optical scalable platform which can be based on ortho-direct card (i.e., vertical cards and horizontal cards which can directly mount with each other via a blind-mate optical connector. In one embodiment, each vertical card functions as a passive Fiber Interface Module (FIM) that provides mechanical support and routing for optical fibers without active electronic components. The FIM can be realized using discrete fiber cabling routed through internal guides or, alternatively, using an optical flexplane that embeds fiber ribbons within a flexible substrate. Fiber paths are secured by clamps or trays within the card to maintain bend radii and protect against strain. In optional configurations, the FIM can include integrated slack‐storage compartments or removable panels to access fiber segments during assembly or reconfiguration. More generally, the FIM can be any hardware component which can enable fiber optic connections and can act as an interface between fiber optic cables and network devices.

FIMs can be provided in various types, such as pluggable transceivers, which can support different data rates and fiber types (single-mode or multi-mode). A given FIM can implement one of several connectivity patterns. In a shuffle‐connectivity embodiment, fiber termini are permuted between front‐ and rear‐facing connectors to balance traffic across downstream switching fabrics. A straight‐through embodiment preserves the one‐to‐one mapping of fibers, enabling direct routing. In an aggregation embodiment, multiple input fibers may be combined into fewer output fibers via passive splitters or wavelength‐division multiplexer modules. These connectivity patterns can be selected during manufacturing or field‐configured by installing different internal modules or re‐routing fiber jumper assemblies.

The front faceplate of each vertical card is populated with high‐density optical connectors, such as EBO‐144 (144‐fiber Expanded Beam Optical) interfaces, which mate with user‐facing fiber assemblies. In addition, the faceplate can include MPO/MTP connectors, LC duplex connectors, SC connectors, Versa Beam EBO connectors, MXC connectors, or the like. In alternative embodiments, the faceplate connectors can include MPO‐16, LC‐48, or other industry‐standard optical interfaces, depending on system requirements. Connector bodies are secured to the faceplate via threaded or snap‐in mounts and can include dust caps or protective shutters to guard against contamination when not in use.

On the rear side, each vertical card presents at least one EBO‐144 blind-mate connector that interfaces directly with corresponding connectors on multiple horizontal cards. It is envisioned many of the connector types disclosed herein can be used in any portion of the apparatus. Blind-mate connectors are aligned by guide pins or sleeves within a mechanical midplane to ensure repeatable engagement without manual fiber handling. In some configurations, the rear connector can be replaced by a multi‐port MPO array or hybrid EBO/MPO adapter, allowing legacy or mixed‐connector systems to interoperate.

Form factor considerations allow each vertical card to span up to 32 rack units (32 RU) in height, maximizing the number of fiber connections per card. A standard 23-inch rack width accommodates up to eight vertical cards side by side, achieving extremely high fiber‐count density. In alternative rack configurations, cards can be manufactured in 16 RU or 48 RU variants, or in custom widths to suit specialized enclosures. To facilitate integration with power and cooling infrastructures, the vertical cards can include provisions for cable‐management brackets, airflow channels, or liquid‐cooling interfaces. In one optional embodiment, cutouts in the card guide frame allow insertion of fan modules or ducting for directed airflow. In another, quick‐disconnect fittings located at the card edges interface with chassis‐mounted coolant manifolds. These features enable the passive FIMs to coexist with active horizontal cards in environments that demand strict thermal control.

In one embodiment, each vertical card is a fully passive module fabricated from sheet‐metal only. The card body provides a structural frame and front and rear faceplates but contains no electronic or optical active components. Front‐facing mechanical areas, for example and without limitation, grommets, clamps, or cable‐tie points, allow customers to install or remove individual fiber or hybrid cables as needed. The rear faceplate likewise features mounting provisions for cable attachment, enabling field‐configurable connections without specialized tooling. The sheet‐metal structure can include integrated cable guides or routing channels stamped or bent into the frame. Notably, the sheet metal structure can be any structure having a substantially large surface constructed from a rigid material. These guides can maintain minimum bend radii for fiber and hybrid cables and prevent undue strain on cable assemblies. In optional configurations, the guides can be removable or reconfigurable, permitting different cable bundles or harnesses to be accommodated within the same card footprint.

Cable ends are prepared with blind-mate connectors that can interface directly with corresponding optical or electrical connectors on horizontal cards. In example, a customer‐supplied fiber cable can terminate in an EBO‐144 or MPO‐16 blind-mate connector at the rear of the vertical card, while the front end terminates in a user‐accessible connector (such as LC, SC, or MPO). This arrangement can decouple the vertical card design from specific connector types, allowing a “create‐your‐own” approach where the customer selects connector style, fiber count, or cable jacket material. To simplify cable procurement and minimize the number of unique cable lengths required, each vertical card can include internal slack storage. Slack storage can take the form of integrated spools, looped channels, or removable trays that hold excess cable length within the card. This feature allows standard‐length cables to be used across multiple card heights or rack positions, reducing inventory complexity and installation errors.

In alternative embodiments, the vertical card frame can include modular inserts or blanking panels that convert portions of the card to cable management only, or that add dust covers and shutters over unused cable ports. Customers can swap these panels in the field to change port density or to protect unused openings. The sheet‐metal design can also incorporate ventilation slots or cutouts for airflow, enabling passive cooling compatibility when mounted alongside heat‐generating horizontal cards. The passive vertical card can be offered in various form factors to suit different rack environments. Standard heights (e.g., 16 RU, 32 RU, or 48 RU) and widths (e.g., 23-inch, 19-inch) can be supported by adjusting the sheet‐metal blank and bend lines. Optionally, the card frame can include quick-release latches or captive screws to facilitate tool-free insertion and removal, further simplifying maintenance and upgrade procedures.

In one embodiment, the apparatus can include one or more horizontal cards, wherein each horizontal card can be an active module and can include a printed-circuit board populated with one or more electronic or photonic components. The card, and more specifically the horizontal card, can include an optical circuit switch (OCS) with micro-electromechanical (MEMS) or liquid-crystal switching elements, an electrical packet switch ASIC such as with co-packaged optics (CPO), a graphics processing unit (GPU) with integrated transceivers, a DRAM memory module with optical I/O, an FPGA-based processing card, or a CPU card. The PCB can be designed with blind-mate connector interfaces along one edge to engage corresponding connectors on vertical cards, and power and control connectors along another edge to engage the chassis midplane or backplane.

In an alternative embodiment, the horizontal card can host mixed-signal functionality by combining, for example, a packet-switch ASIC and an FPGA on the same board. The board stack-up and layer count can be adjusted to accommodate high-speed electrical traces and power planes, and the card envelope can conform to standard rack-unit widths and depths. Connector pitch and mounting hole locations can be varied to support different midplane or guide-pin configurations without altering the card’s active-component layout. The horizontal cards can include a front faceplate. The front faceplate of each horizontal card can include integrated cooling features. In one configuration, the faceplate is populated with axial or centrifugal fans aligned with airflow channels in the chassis to provide directed air cooling across high-power components. In optional liquid-cooled embodiments, the faceplate can include quick-disconnect coolant fittings and cold-plate interfaces that route coolant through microchannels on the PCB or attached heat sinks. Fan speed sensors and temperature probes can be included on the faceplate for dynamic thermal management.

Optical connectivity to external networks is routed exclusively through the vertical cards. Each horizontal card’s blind-mate optical interface engages a mating connector on a vertical card using Expanded Beam Optical (EBO) or multi-fiber push-on (MPO) blind-mate connectors. This design means that no external fiber or hybrid cables are directly attached to horizontal cards. In another embodiment, horizontal cards can include a small set of management or diagnostic optical ports, such as LC duplex connectors, for local testing, but these remain optional and do not interfere with the primary vertical-card–based connectivity. Because all external cables remain attached to the passive vertical cards, a failed horizontal card can be removed and replaced without disconnecting any field-installed cables. Cards can be designed for hot-swap operation, with ejector handles or lever-actuated retention clips that release the blind-mate connectors and power/data midplane interfaces in a controlled sequence. In an alternative cold-swap embodiment, the card removal sequence can be interlocked with chassis power rails to prevent damage to components or data loss.

Additional configurations can include on-card management controllers that communicate status and health metrics over a serial bus to a system management processor. Horizontal cards can include redundant power-input circuits that draw from separate busbar feeds in the midplane. For specialty applications, cards can be outfitted with signal-integrity test points or embedded loopback optics to facilitate in-field diagnostics.

In one embodiment, each horizontal card is equipped with external I/O ports on its faceplate. These ports can include OSFP-Plus transceiver cages, MPO-16 connectors, or EBO-144 expanded-beam interfaces, depending on system requirements. The faceplate connectors can mate to field-installed fiber or hybrid cables, while the opposite edge of the card can engage blind-mate optics or power interfaces in the midplane. Connector modules are secured to the card’s front bezel via threaded standoffs or snap-in mounts and can be swapped to support different port densities or connector types. By placing all external I/O on the front and rear faceplates, the platform of the present disclosure can achieve very high port density without being constrained by the limited area of a single panel. Both front-side and rear-side cards can present user-accessible connectors, effectively doubling the available faceplate real estate. This arrangement also decouples port density from card pitch, allowing narrow-pitch card slots to carry large numbers of I/O channels without sacrificing mechanical robustness.

In an embodiment, the system uses a liquid-cooled midplane in place of an air-cooling backplane. The midplane incorporates internal coolant channels routed through manifolds that align with cold-plate interfaces on each horizontal card. Coolant inlet and outlet quick-disconnect fittings are positioned at the chassis edges for tool-free fluid connections. In addition to cooling, the midplane provides power distribution via integrated busbars. These busbars can carry DC voltages required by the horizontal cards and can include fusing or current-sense shunts for each slot. Optional connectivity on the midplane can include management-plane signal traces (e.g., I²C, SMBus, or JTAG), synchronous clock distribution, or low-speed monitoring links. Connectorized headers or surface-mount connectors or fixtures on the midplane allow these signals to interface directly to card-edge connectors on horizontal cards.

The midplane also performs mechanical alignment for blind-mate mating of horizontal and vertical cards. Guide pins or alignment sleeves are molded or machined into the midplane’s surface at each card slot. Corresponding holes or bushings on the mating card PCBs ensure precise lateral and angular positioning, limiting insertion float to within optical alignment tolerances. In alternative embodiments, the guide features can be spring-loaded or include bushings for reduced wear over repeated insertions. In other configurations, the midplane can be adapted for hybrid cooling schemes, such as without limitation combining liquid cooling for high-power ASICs with directed airflow for lower-power components. Additional midplane functions can include integrated fiber-optic management (e.g., micro-duct trays) or embedded temperature and flow sensors for real-time monitoring. The liquid-cooled midplane concept can also be scaled to support varied chassis heights (e.g., 1RU to 7RU) and widths (19-inch or 23-inch racks) by modifying the manifold layouts and connector arrangements.

### Embodiments

The devices of the present disclosure can incorporate Expanded Beam Optical (EBO) connectors to facilitate both electrical and optical connectivity throughout the system. Unlike conventional physical-contact fiber-optic interfaces, EBO connectors utilize collimating and focusing optics to expand the light beam at the connector interface. This expanded-beam approach significantly increases tolerance to dirt, dust, and minor misalignment, allowing the system to maintain optical performance even in the presence of contaminants. Consequently, EBO connectors may be permanently installed as “optical blind-mate” interfaces between front- and rear-panel modules, including within sealed enclosures that are inherently inaccessible for routine maintenance. Because EBO connectors do not rely on direct physical contact between fiber endfaces, they do not require cleaning, thereby reducing maintenance demands, improving long-term reliability, and enabling tool-free mating in harsh or confined environments. The enhanced environmental tolerance of EBO connectors allows for the inclusion of a first set of connectors at the front portion of the apparatus and a second set at the rear, without necessitating access for cleaning. In some aspects, the EBO connectors disclosed herein are intentionally positioned in locations that are not readily accessible, as their design eliminates the need for such accessibility.

In one embodiment, each vertical card can function as a replaceable backplane within the optical interconnection system. The vertical card comprises a rigid sheet-metal or composite frame that houses blindmate connector interfaces along its rear edge for engagement with horizontal cards, and a corresponding set of front-face connectors for external cabling. By removing a vertical card and installing an upgraded or replacement unit, the system’s backplane topology can be altered or restored without disturbing the horizontal modules or their external connections. Mechanical guide pins and alignment sleeves integrated into the chassis ensure precise mating during replacement, while captive fasteners or tool-free latches secure the card in place.

In another embodiment, the vertical cards serve as replaceable faceplate Fiber Interface Modules (FIMs). These FIM vertical cards present densely packed optical connectors on both the front and rear faceplates—such as multi-fiber expanded-beam or MPO arrays—and include internal routing channels or trays for cable management. When a horizontal active card needs replacement, the faceplate FIM remains in situ, maintaining all external fiber connections. This decoupling of faceplate and horizontal card engagement eliminates the need to disconnect user cabling during module swaps.

The system supports a hybrid optical blindmate platform capable of accommodating a mixture of card types within the same chassis. Horizontal slots can receive GPU cards, DRAM cards with optical I/O, high-speed packet switches, or optical circuit switches (OCS), while vertical slots accept FIMs or backplanes that route data between them. At installation time, the ratio of GPU to DRAM to switching cards can be selected to meet application-specific requirements. Blindmate optical connectors on the vertical cards align with corresponding optics on the horizontal cards, enabling high-density interconnection without manual fiber handling.

Thermal management is provided via air-cooled, liquid-cooled, or hybrid schemes. In air-cooled implementations, the chassis includes fan trays and airflow ducts that direct ambient air across card surfaces. In liquid-cooled embodiments, the midplane or dedicated cooling manifold incorporates coolant channels that interface with cold plates on the cards. Hybrid configurations combine directed airflow for low-power modules (e.g., OCS cards) with liquid cooling for high-power modules (e.g., GPU cards), allowing the system to support both ultra-high power dissipation and low-power operation within a single enclosure. Vertical cards can include a passive shuffle function to enable ultra-high radix switching architectures. In a shuffle embodiment, internal fiber ribbons or flexplanes route optical channels according to a permutation mapping, interconnecting multiple horizontal card submodules in a non-blocking fashion. This passive shuffle module can be fabricated from polymer optical waveguides or fiber harness assemblies secured by internal trays. Alternative embodiments include straight-through or aggregation FIMs that provide one-to-one or many-to-one fiber mappings, respectively.

The system permits mixing and matching different vertical card types within a single chassis. For example, in an eight-slot vertical array, four slots can be populated with shuffle modules, two with straight-through modules, one with a busbar power distribution card, and one with a control-signal interconnect card. Unused slots can accept filler panels that maintain airflow or mechanical support. All vertical cards share a common mechanical form factor (same height, width, and mounting features) allowing customer-specific optical connectivity variants to be produced using interchangeable internal modules without altering the external chassis design. In one embodiment, the system integrates ortho-direct optical EBO interfaces with a midplane that also provides blind-mate power distribution and liquid-cooling connections. The midplane houses arrays of EBO lens assemblies aligned to the blind-mate connectors on both horizontal and vertical cards, while adjacent busbar contacts deliver DC or AC power via blind-mate contacts. Integrated quick-disconnect fittings in the midplane supply coolant to cold plates on active cards. In alternative configurations, the midplane can include management-plane signal headers or air-cooling ducts in place of or in addition to liquid-cooling channels.

The chassis presents accessible front and rear faceplates at the system level, each populated with high-density optical and/or electrical connectors. Front-side cards mate to fiber assemblies or transceiver cables via user-accessible ports, while rear-side cards can mirror this arrangement or provide alternative I/O. By distributing external connections across both faceplates, the platform maximizes port count without increasing card pitch. In optional embodiments, one faceplate can be dedicated to low-speed management signals or legacy interfaces, while the other handles high-speed data channels. Vertical cards in the system are not constrained by standard printed-circuit-board height limitations. Instead of PCBs, vertical modules can be fabricated from sheet-metal frames or flexible substrates with embedded optical flexplanes. These carriers can span the full height of a rack unit (e.g., 32 RU or more), hosting multiple blind-mate connector arrays along their length. In alternative form factors, shorter or wider vertical cards (e.g., 16 RU, 48 RU, 19-inch or 23-inch widths) can be provided to suit custom enclosures.

Each vertical card can include an integrated and configurable optical shuffle function. Passive fiber ribbons or flexplane traces within the card permute optical channels according to a mapping table, enabling non-blocking interconnection among horizontal-card submodules. In other embodiments, vertical cards can be configured for straight-through or aggregation connectivity by installing alternative internal modules or rerouting jumper assemblies. The shuffle mapping can be fixed at manufacture or field-reconfigurable via modular inserts. The system permits a mixture of multiple types of vertical cards in one working chassis. For example, an eight-slot vertical array can accommodate shuffle modules, straight-through FIMs, busbar power-distribution cards, management-signal cards, or filler panels. Each card shares the same mechanical interface (i.e., mounting features, guide-pin holes, and chassis retention latches) allowing customers to select the precise mix of functions at installation. Unused slots can accept blanking panels that maintain airflow or provide dust protection.

Alignment between horizontal and vertical blind-mate connectors is achieved by using the midplane as an alignment mechanism to reduce the required float during mating. Guide pins or precision sleeves on the midplane engage corresponding holes or bushings on each card, constraining lateral and angular movement to within optical-alignment tolerances. Vertical cards can also include orifices or clamping features near their rear faceplates to receive and hold customer-installed cable assemblies in fixed positions. This ensures that when a horizontal card is inserted, its blind-mate connector aligns accurately with the held cable without manual adjustment.

One aspect of the present disclosure pertains to an optical interconnecting apparatus, comprising at least one horizontal card having an optical blind-mate connector, at least one vertical card positioned orthogonally to the horizontal card and having an optical blind-mate connector configured to directly mate with the optical blind-mate connector of the horizontal card, a mechanical midplane positioned between the horizontal and vertical cards, configured to provide alignment of the optical blind-mate connectors to reduce float required during mating, and wherein the vertical card includes an orifice configured to receive and hold an optical cable in a fixed position to enable blind mating to the horizontal card.

The apparatus can include wherein the optical blind-mate connectors are Expanded Beam Optical (EBO) connectors. The apparatus can include wherein the EBO connectors each support at least 144 optical fibers. The apparatus can include wherein the mechanical midplane further comprises at least one of an integrated busbar for power distribution, an electrical signal plane, an air-cooling interface, or a liquid cooling manifold for distributing cooling fluid. The apparatus can include wherein the vertical card includes a fiber interface module FIM configured to perform at least one of: shuffle optical connectivity, straight-through optical connectivity, or aggregation optical connectivity.

In an embodiment, the midplane could also be made of Printed Circuit Board material that carries electrical Control Plane signals while still providing the mechanical properties already described and still maintaining optical ortho-direct. These electrical connections would not be ortho-direct; they would be standard card-to-backplane style of electrical connectors. The PCB midplane could have large holes to enable front-to-back airflow since the electrical connectivity would be for a small number of signals (ie control plane rather than dataplane).

The apparatus can include wherein the vertical card comprises a passive structure without electronic components. The apparatus can include wherein the passive structure comprises sheet metal adapted to mechanically support optical cables. The apparatus can include wherein the horizontal card comprises at least one active electronic components that is one of: an optical circuit switch (OCS), an electrical packet switch, a graphics processing unit (GPU), a dynamic random-access memory (DRAM), a central processing unit (CPU), or an FPGA. The apparatus can include wherein the horizontal card includes input/output optical connectors positioned on a faceplate.

The apparatus can include wherein the faceplate optical connectors comprise at least one of OSFP, MPO, or EBO connectors. The apparatus can include a plurality of vertical cards, wherein at least two vertical cards differ in functionality, including at least one shuffle connectivity vertical card and at least one straight-through connectivity vertical card. The apparatus can include the vertical cards that have a vertical dimension substantially greater than dimensions limited by PCB manufacturing processes.

The apparatus can include front and rear faceplates providing external accessibility for optical connections. The apparatus can include wherein the vertical cards are configurable by selectively routing optical cables within the vertical card to establish desired optical connectivity patterns. The apparatus can include slack storage integrated into the vertical card to facilitate configurable optical connectivity. The apparatus can include wherein the horizontal card is replaceable without disconnecting optical cables connected externally to the vertical card. The apparatus can include wherein the vertical cards can function as replaceable optical backplanes. The apparatus can include wherein the vertical card is configured to support a vertical dimension substantially equal to the entire height of a rack unit (RU) enclosure.

Another aspect of the present disclosure can include a mechanical midplane apparatus for use in an optical interconnection system having a mechanical support structure positioned between horizontal and vertical cards oriented orthogonally to each other; guide pins configured to facilitate accurate alignment and mating of optical blind-mate connectors located on the horizontal and vertical cards; and at least one integrated functionality selected from the group consisting of: an electrical busbar configured for power distribution; a manifold configured for liquid cooling fluid distribution; and interfaces for air-cooling distribution. The mechanical midplane can include wherein the mechanical midplane integrates both an electrical busbar and a liquid cooling manifold.

### Conclusion

As used herein, including in the claims, the phrases “at least one of” or “one or more of” a list of items refer to any combination of those items, including single members. For example, “at least one of: A, B, or C” covers the possibilities of: A only, B only, C only, a combination of A and B, a combination of A and C, a combination of B and C, and a combination of A, B, and C. Additionally, the terms "comprise," "comprises," "comprising," "include," "includes," and "including" are intended to be non-limiting and open-ended. These terms specify essential elements or steps but do not exclude additional elements or steps, even when a claim or series of claims includes more than one of these terms.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

Although operations, steps, instructions, and the like are shown in the drawings in a particular order, this does not imply that they must be performed in that specific sequence or that all depicted operations are necessary to achieve desirable results. The drawings may schematically represent example processes as flowcharts or flow diagrams, but additional operations not depicted can be incorporated. For instance, extra operations can occur before, after, simultaneously with, or between any of the illustrated steps. In some cases, multitasking and parallel processing might be beneficial. Furthermore, the separation of system components described should not be interpreted as mandatory for all implementations, as the program components and systems can be integrated into a single software product or distributed across multiple software products.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes, and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

What is claimed is:

1. An optical interconnection apparatus, comprising:
at least one horizontal card having an optical blind-mate connector;
at least one vertical card positioned orthogonally to the horizontal card and having an optical blind-mate connector configured to directly mate with the optical blind-mate connector of the horizontal card; and
a mechanical midplane positioned between the horizontal and vertical cards, configured to provide alignment of the optical blind-mate connectors to reduce float required during mating.

2. The apparatus of claim 1, wherein the vertical card includes an orifice configured to receive and hold an optical cable in a fixed position to enable blind mating to the horizontal card.

3. The apparatus of claim 1, wherein the optical blind-mate connectors are Expanded Beam Optical (EBO) connectors.

4. The apparatus of claim 3, wherein the EBO connectors each support at least 144 optical fibers.

5. The apparatus of claim 1, wherein the mechanical midplane further comprises at least one of:
an integrated busbar for power distribution;
a liquid cooling manifold for distributing cooling fluid;
an electrical signal plane; or
an air-cooling interface.

6. The apparatus of claim 1, wherein the vertical card comprises a fiber interface module (FIM) configured to perform at least one of:
shuffle optical connectivity;
straight-through optical connectivity; or
aggregation optical connectivity.

7. The apparatus of claim 1, wherein the vertical card comprises a passive structure without electronic components.

8. The apparatus of claim 6, wherein the passive structure comprises sheet metal configured to mechanically support optical cables.

9. The apparatus of claim 1, wherein the horizontal card comprises at least one active electronic component that is one of:
an optical circuit switch (OCS);
an electrical packet switch;
a graphics processing unit (GPU);
a dynamic random-access memory (DRAM) module;
a central processing unit (CPU); or
a field programmable gate array (FPGA).

10. The apparatus of claim 1, wherein the horizontal card includes input/output optical connectors positioned on a faceplate.

11. The apparatus of claim 9, wherein the faceplate optical connectors comprise at least one of Octal Small Form-factor Pluggable (OSFP), Multi-fiber Push On (MPO), or Expanded Beam Optical (EBO) connectors.

12. The apparatus of claim 1, further comprising:
a plurality of vertical cards, wherein at least two vertical cards differ in functionality, including at least one shuffle connectivity vertical card and at least one straight-through connectivity vertical card.

13. The apparatus of claim 1, further comprising:
front and rear faceplates providing external accessibility for optical connections.

14. The apparatus of claim 1, wherein the vertical card is configurable by selectively routing optical cables within the vertical card to establish desired optical connectivity patterns.

15. The apparatus of claim 14, further comprising cable slack storage integrated into the vertical card to facilitate configurable optical connectivity.

16. The apparatus of claim 1, wherein the horizontal card is replaceable without disconnecting optical cables connected externally to the vertical card.

17. The apparatus of claim 1, wherein the vertical cards are configured to function as replaceable optical backplanes.

18. The apparatus of claim 1, wherein the vertical card is configured to support a vertical dimension substantially equal to an entire height of a rack.

19. A mechanical midplane apparatus for use in an optical interconnection system, comprising:
a mechanical support structure positioned between horizontal and vertical cards oriented orthogonally to each other; and
guide pins configured to facilitate accurate alignment and mating of optical blind-mate connectors located on the horizontal and vertical cards.

20. The apparatus of claim 19, further comprising at least one integrated functionality that includes one of
an electrical busbar configured for power distribution;
a manifold configured for liquid cooling fluid distribution; and
interfaces for air-cooling distribution.
